(19) United States
(12) Patent Application Publication
(10) Pub. No.: US 2008/0268201 A1
(43) Pub. Date: Oct. 30, 2008

(54) Low OH glass for infrared applications

(76) Inventors: Richard Michael Fiacco, Corning, NY (US); Kenneth Edward Hrdina, Horseheads, NY (US); Daniel Raymond Sempolinski, Painted Post, NY (US)

Correspondence Address: CORNING INCORPORATED, SP-TI-3-1, CORNING, NY, 14831, US

(21) Appl. No.: 12/082,360

(22) Filed: Apr. 10, 2008

Related U.S. Application Data
(60) Provisional application No. 60/926,680, filed on Apr. 27, 2007.
(60) Provisional application No. 61/004,423, filed on Nov. 27, 2007.

(51) Int. Cl. C03B 20/00; B32B 3/10; B32B 17/00

(52) U.S. Cl. 428/131; 65/17.3; 65/17.2; 65/17.6; 65/17.5; 428/426; 428/325; 428/410

(57) ABSTRACT

A fused silica glass having a composition for use in bulk IR optical applications. The fused silica glass has a OH concentration of less than 5 ppm (parts per million) by weight and an absorbance of less than about 50 ppm/cm at a wavelength of about 1.3 μm. A method of making the fused silica glass is also described.

### CROSS REFERENCE TO RELATED APPLICATIONS

This application claims the benefit of U.S. Provisional Application No. 60/926,680, filed Apr. 27, 2007, and U.S. Provisional Application No. 61/004,423, filed Nov. 27, 2007.

### BACKGROUND OF INVENTION

The invention relates to fused silica glass and articles made therefrom. More particularly, the invention relates to fused silica glass having low concentrations of hydroxyl (OH) groups. Even more particularly, the invention relates to fused silica glass having low OH concentrations that exhibit low absorbance of infrared radiation.

Fused silica optical components used in the semiconductor field, particularly in the area of lithography, have stringent requirements for both dynamic and static properties. Fused silica can be produced using a variety of methods. Some of these processes provide excellent control of the chemistry, thus producing fused silica glasses having superior homogeneity and transmission properties. While reforming techniques have been used to produce larger size optical components for transmission in the UV spectrum, they have not been used to prepare comparable components for transmission at infrared (IR) wavelengths. Whereas planar soot methods yield large scale optics for use in the deep UV, compositions and properties needed to meet the needs of large scale optics in the infrared region of the spectrum have not been developed.

### SUMMARY OF INVENTION

The present invention provides a fused silica glass having a composition for use in bulk IR optical applications, such as windows and lenses. The fused silica has a OH concentration of less than 5 ppm (parts per million) and an absorbance of less than about 50 ppm/cm at a wavelength of about 1.3 μm.

Accordingly, one aspect of the invention is to provide a fused silica glass. The fused silica glass has an OH concentration of less than about 5 ppm of OH. The fused silica glass also has an absorbance of less than about 50 ppm/cm at a wavelength of about 1.3 μm.

A second aspect of the invention is to provide a fused silica glass. The fused silica glass has an absorbance of less than about 50 ppm/cm at a wavelength of about 1.3 μm. The fused silica glass has an index homogeneity, measured at 632 nm, of less than about 5 ppm over an aperture size of at least 75 cm².

A third aspect of the invention is to provide a method of making a fused silica glass comprising less than about 5 ppm of OH and having an absorbance of less than about 50 ppm/cm at a wavelength of about 1.3 μm. The method comprises the steps of: forming a porous preform of silica soot, the preform having a predetermined density distribution; and consolidating the preform at a predetermined temperature and under a controlled atmosphere to produce the fused silica glass, wherein the fused silica glass has an OH concentration of less than about 5 ppm and an absorbance of less than about 50 ppm/cm at a wavelength of about 1.3 μm.

These and other aspects, advantages, and salient features of the present invention will become apparent from the following detailed description, the accompanying drawings, and the appended claims.

### BRIEF DESCRIPTION OF THE DRAWINGS

FIG. 1 is a schematic representation of a ready-to-flow notched glass tube; and

FIG. 2 is a schematic representation of the notched glass tube after thermal reflow.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise any number of those elements recited, either individually or in combination with each other. Similarly, whenever a group is described as consisting of at least one of a group of elements or combinations thereof, it is understood that the group may consist of any number of those elements recited, either individually or in combination with each other.

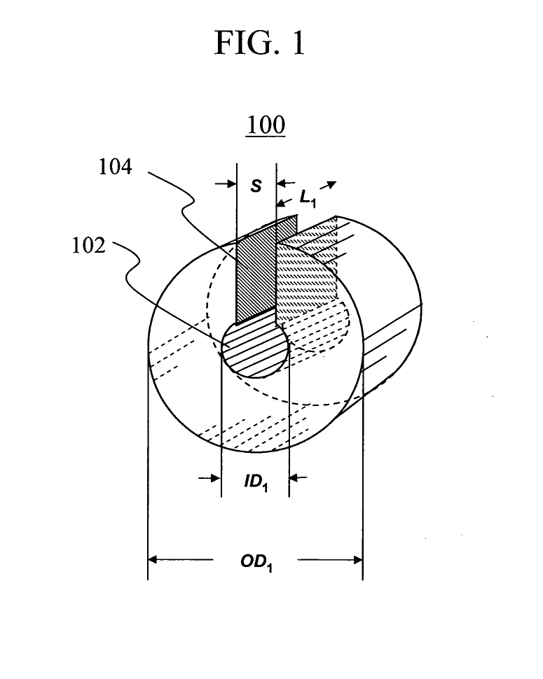

Referring to the figures and to FIG. 1, in particular, it will be understood that the illustrations are for the purpose of describing particular embodiments of the invention and are not intended to limit the invention thereto.

As used herein, the terms “hydroxyl(s)” and “OH” refers to a moiety or a group of moieties. Unless otherwise specified, each individual moiety consists of an oxygen atom and an atom of a naturally occurring hydrogen isotope (i.e., protium or deuterium). The terms “hydroxyl(s)” and “OH” may also be used to describe any mixture of hydroxyl moieties containing either isotope in any proportion, unless otherwise stated. The oxygen atom may be any of the naturally occurring isotopes of oxygen (¹⁶O, ¹⁷O, or ¹⁸O), or mixtures thereof, at any proportion. As used herein, n(OH) means the total number of OH moieties in a material.

The present invention provides a fused silica glass and an article made therefrom. Both the fused silica glass and article have an OH concentration of less than about 0.5 ppm (parts per million) by weight and have high infrared transmission (i.e., low absorbance at IR wavelengths). In one embodiment, the OH concentration is less than about 0.1 ppm. The absorbance of the fused silica glass is less than about 50 ppm/cm at a wavelength of about 1.3 μm (1.315 μm).

The fused silica glass also has an index homogeneity (PV), measured at 632 nm, of less than about 5 ppm over a required optical aperture. The term “index homogeneity” refers to the differences in refractive index as determined from PV, or maximum (“peak”) and minimum (“valley”), values of refractive indices measured over the required aperture. In one embodiment, the fused silica glass has an index homogeneity of less than about 1 ppm. Index homogeneity is achieved by keeping the variation of OH content within the fused silica glass to less than about 2 ppm and the variation in halogen (chlorine, fluorine, bromine) content to no more than 20 ppm. In one embodiment, the halogen content is no more than about 10 ppm. In addition, index homogeneity is achieved in a system, such as, for example, annealed glass, having a low level of stress.

The high infrared transmission of the fused silica glass is achieved by keeping the OH concentration at a level that is less than about 5 ppm by weight and, in one embodiment, less than about 0.1 ppm. In addition, metal impurities such as Fe, Ni, Ti, Ge, Pb, K, Na, Li, and the like are all individually maintained at concentrations of less than about 4 ppb (parts per billion) by weight. The total concentration of metal impurities is less than 10 ppb and, in one embodiment, less than 5 ppb. To achieve the desired infrared transmission, chlorine (Cl) content may range from 1 to 1500 ppm by weight.

The fused silica glass described herein may be used to form a fused silica article having superior index homogeneity and infrared absorbance over dimensions that are greater than many of those articles obtained to date. This is accomplished in part by maintaining uniform concentrations of hydroxyls and halogens within the aperture. In one embodiment, the fused silica glass forms an article having an optical aperture of at least about 75 cm². In one embodiment, the fused silica article has a diameter of at least about 100 mm. In another embodiment, the fused silica article has a thickness of greater than 10 mm. In one embodiment, the fused silica article is an optical element such as, for example, a lens, a window, or the like, that may be used in laser systems, including power generation and measurement systems.

Seed or inclusion defects within the fused silica glass and fused silica article are less then about 200 μm in size. In one embodiment, the size of individual seed or inclusion defects is less than about 100 μm and, in another embodiment, less than about 50 μm. The concentration of seeds or inclusions within the fused silica glass and fused silica article is less than 1 seed per cm³. In one embodiment, the concentration is less than about 1 seed per 10 cm³ and, in another embodiment, less than about 1 seed per 100 cm³. The seed concentration is minimized in part by generating a uniform soot density during the flame deposition soot making process. Uniform soot density minimizes differential shrinkage which could result in structural damage during consolidation and trapping of gases, some of which could evolve during consolidation. The use of helium, which has high permeability in fused silica and can therefore be removed by diffusion, during consolidation also contributes to minimization of seed concentration. Seed concentration is also reduced by inclusion of a processing step to outgas helium, thereby ensuring removal of helium and preventing “reboil” during subsequent processing of the material. In addition, the use of a high temperature reflow operation enables vacuum seeds, such as those left over after helium removal, to be collapsed.

A method of making the fused silica glass described herein is also provided. Process steps for making this glass include forming a porous preform of silica soot having the required density distribution, and consolidating the porous preform under tight controls of temperature and atmosphere to produce the required OH level and to avoid concentration gradients for OH and the halogen species.

There are many different routes for producing the porous perform of silica soot. These include outside vapor deposition (OVD), vapor axial deposition (VAD), inside vapor deposition (IVD), planar soot deposition (PSD), and sol/gel methods.

In one embodiment, a sol/gel method is used to produce the porous perform. Such a method is described in U.S. Pat. No. 4,789,389, by Paul M. Schermerhom et al., entitled “Method for Producing Ultra-High Purity, Optical Quality, Glass Articles,” filed on May 20, 1987 and issued on Dec. 6, 1988, the contents of which are incorporated by reference herein in their entirety. A solution of at least one silicon-containing organic compound is first prepared. The silicon-containing compound has as a general formula of either Si(OR)₄ or Si(OR)₃, where R is an alkyl group. Non-limiting examples of suitable alkyl groups include: tetraethylorthosilicate (Si(OC₂H₅)₄, also referred to herein as “TEOS”); tetramethylorthosilicate (Si(OCH₃)₄); methyltrimethoxysilane (SiCH₃(OCH₃)₃); and the like. The silicon-containing organic compound may be partially hydrolyzed. For example, partially hydrolyzed TEOS is a suitable starting material for preparing gels. While a single silicon-containing organic compound is typically used to form a gel, mixtures of such compounds may be used as well. In one embodiment, the solution is an aqueous solution comprising an acid, such as hydrochloric acid, formic acid, nitric acid, or the like, to act as a gelation catalyst. Organic solvents, such as ethanol or the like, may be added to improve miscibility.

The solution containing the silicon-containing organic compound is then gelled. Gelation results in polymerization of the silicon and production of an alcohol, such as—in the case of TEOS—ethanol. Typical gelation times for solutions having pH values of 1-2 range from 1 to 4 hours at temperatures from about 60° to about 75° C. Gelation times may be reduced to a matter of seconds by heating the solution, or by neutralizing the solution pH by adding a second, basic solution.

Once gelation is complete, the gel is dried to remove residual water and alcohol (and thus carbon), and to fragment the gel into granules having a mean particle size of less than about 1 mm. The drying step is typically carried out in the same reactor as that used to prepare the gel. Drying temperatures in this instance are greater than about 250° C., and drying times on the order of 30 hours are typical. The gel is either purged with an inert atmosphere, such as argon, or the like, subjected to a vacuum, or sequentially subjected to purging and vacuum to remove water and alcohol.

After drying and fragmentation, the gel granules are sintered to a density that approximates their maximum theoretical density. During the sintering process, the polymeric structure of the gel granules relaxes and water is released. The water release affects the apparent viscosity of the granules, causing the pores of the granules to collapse. The sintering step is carried out at temperatures of less than about 1150° C., usually in a quartz reactor to maintain the chemical purity of the granules. A sintering period of about one hour at temperatures in a range from about 900° C. up to about 1,000° C. is generally sufficient to achieve full densification of the granules, with the actual time required depending on the pore size of the gel. Sintering may be performed in a variety of atmospheres, such as helium, helium/oxygen, argon/oxygen, and air. In one embodiment, sintering in a helium/oxygen atmosphere is preferred over sintering in an argon/oxygen atmosphere. The gel granules may be used to form high density green bodies. In particular, the granules may be used as starting material for such processes as slip casting, injection molding, extrusion molding, cold pressing, and the like.

Due to its solution-based nature, the sol/gel process is more susceptible to the introduction of contaminants and defects than vapor-based deposition processes. Such contaminants include organic compounds, metals, and the like. In addition, air bubbles introduced to the solution of silicon-containing precursors may result in seed formation. Thus, the levels of such contaminants should be rigorously controlled during the sol/gel process and the use of cleanup processes described herein is advantageous.

As described in U.S. Patent Application Publication No. US 2007/0059533 A1, by Steven Roy Burdette et al., entitled “Thermal Reflow of Glass and Fused Silica Body,” filed on Aug. 3, 2006, the contents of which are incorporated by reference herein in their entirety, high purity synthetic silica glass may be produced by known vapor deposition processes, such as outside vapor deposition (OVD), inside vapor deposition (IVD), and vapor axial deposition (VAD). These processes use inorganic silicon precursor compounds, including silicon halides, or organosilicon precursor compounds, such as octamethylcyclotetrasiloxane (“OMCTS”) and the like, either separately or in combination with each other. OVD, IVD and VAD are typically soot-to-glass processes in which silica soot particles are generated by flame hydrolysis of the precursor compounds to form soot preforms, which are in turn consolidated to form transparent fused silica glass.

In the case of OVD, silica soot preforms are formed on the outside surface of an axially rotating mandrel of silica glass or other materials. The mandrel may be a solid core rod, a tube, or the like. The soot preforms may be consolidated either prior to or following removal of the mandrel. If consolidation is performed prior to the removal of the mandrel, the consolidated silica glass generally has a composition that is different from that of the mandrel. In this instance, the mandrel is removed—usually by drilling or the like—to obtain a glass tube that can be used as a precursor glass tube. If the soot preform is consolidated after the mandrel is removed, the consolidated glass directly forms a fused silica glass tube. It may be desirable to subject the as-consolidated glass with the mandrel remaining in the center to further processing—such as, for example, reflow—before removing the mandrel. If a glass tube is used as the mandrel, the soot preform may be consolidated without removing the mandrel. The thus-formed glass tube with inner mandrel tube can be used as a precursor glass tube directly, cut to form a notch, and then thermally reflowed to form a glass plate. If the glass tube is rolled out to form a flat plate, the glass tube mandrel forms at least a portion of the surface part of the plate. The glass plate can then be ground to remove that portion comprising the glass tube mandrel to obtain a glass plate having a composition and properties that are essentially homogeneous.

In the case of IVD, silica soot preforms are formed on the inner surface of an axially rotating tube that may be made of silica glass or other materials. The soot preforms may be consolidated either prior to or following removal of the outside tube. If the soot is consolidated prior to the removal of the tube, the consolidated silica glass generally has a different composition from that of the outside tube. The outside tube may be removed after consolidation, with or without further processing (e.g., further thermal reflow such as, for example, the squash process described below) to form a ready-to-flow silica glass tube. The outside tube may, however, be retained after consolidation and during subsequent formation of a precursor glass tube, formation of a notch in the consolidated tube, and thermal reflow of the notched glass tube. In this case, the outside tube forms the surface portion of the glass plate produced after thermal reflow. The glass plate can then be ground to remove the surface portion to provide a glass plate having essentially homogeneous composition and properties. If the consolidation of the soot preform is performed after removal of the outside tube, the consolidated glass forms a fused silica glass tube having an essentially uniform composition. The glass tube may then be used directly as a precursor glass tube in which a notch or slot is formed. It may be desirable, however, to subject the as-consolidated tube to further processing—such as reflow by the squash process—before use as a ready-to-flow notched glass tube.

Silica glass formed by VAD may be processed to form the ready-to-flow silica glass tube according to the processes described above in connection with OVD and IVD.

The vapor deposition processes mentioned above have been previously used in the art in producing optical waveguide preforms. Such preforms typically have a relatively long length and small diameter. Thus, silica glass tubes directly made from these waveguide preforms (by removing the mandrel, for example) tend to have a relatively long length and small tube wall thickness. The resulting reflowed glass plate, however, does not have sufficient width or thickness for other end uses of the silica glass. The production of optical blanks for lenses or windows that may be used in laser systems, including power generation and measurement systems, or photomask substrates and lens elements used in modern photolithography devices, for example, requires that the ready-to-flow notched glass tube have a thicker tube wall and larger tube outer diameter.

The “squash process” previously mentioned herein can be used to form slim fused silica cylinders or tubes of the dimension of optical waveguide preforms into fused silica glass tubes having a tube wall thickness and a tube outer diameter that are suitable for the production of optical blanks for use as optical elements in in laser systems and photolithography. In the squash process, a precursor glass cylinder having a precursor cylinder axis, an initial length L₀ in the direction of the precursor cylinder axis, and a precursor cylinder initial outer diameter OD₀ is first provided. The precursor glass cylinder is thermally reflowed and optionally pressed. In one embodiment, a cylindrical inner cavity is optionally formed, typically by drilling. The cylindrical cavity is oriented in a direction essentially parallel to the precursor cylinder axis, such that the precursor glass tube formed has a longitudinal tube axis, an outer diameter OD₁ and a length L₁ in the direction of the tube axis. Following the squash process, outer diameter OD₁ is greater than initial diameter OD₀ and length L₁ is less than initial cylinder length L₀—i.e., L₁<L₀, and OD₁>OD₀. In one embodiment, the longitudinal tube axis is essentially parallel to—or the same as—the precursor cylinder axis of the precursor glass cylinder.

In one embodiment, the precursor glass cylinder includes an inner glass cane that is located approximately at the center of the precursor glass cylinder and has a diameter of ID₀. The inner glass cane has either the same or a different composition and properties as those of the surrounding glass. The inner glass cane may be removed—typically by drilling—during the thermal reflow step.

Once the inner glass cane is removed, a notch is cut through the tube wall of the precursor glass cylinder. The notch is cut in the direction of—and preferably parallel to—the longitudinal center axis of the precursor glass tube. The notch formed in the precursor glass tube may have one of several cross-sectional geometries, including an essentially rectangular cross-section, and a trapezoidal (truncated V-shaped) cross-section.

In one embodiment, the notch formed in the wall of the ready-to-flow notched glass tube has a center plane passing through the longitudinal tube center axis of the ready-to-flow notched glass tube, and the two sides of the notch beside the center plane are essentially symmetric. If the outer cylinder and the center cylindrical cavity of the ready-to-flow notched glass tube are concentric, the notch may be formed at any location of the circumference of the tube wall. If the outer cylinder and the center cylindrical cavity of the ready-to-flow notched glass tube are eccentric, the notch may be formed at the location where the center plane of the notch passes the maximal or minimal thickness—preferably the minimal thickness—of the precursor glass tube.

The notch can be formed by various methods and equipment known in the art, such as cutting with a wire saw, water jet, band saw, combinations thereof, and the like. In one embodiment, the notched glass tube is thoroughly cleaned after cutting to eliminate or minimize any contamination introduced by the cutting process. Such cleaning may include acid (HCl, HF, or the like) washing, solvent washing, Cl₂ treatment at high temperature, or the like.

Thermal reflowing of the ready-to-flow notched tube is carried out at an elevated temperature such that the notched tube reflows to form a glass plate. The formed glass plate, in one embodiment, has two major surfaces and an optical axis essentially perpendicular to the two major surfaces. Thermal reflowing is conducted with the notched side of the tube and the notch facing upwards and the side of the tube opposite the notch side placed on the surface of a support, such as the bottom plate of a crucible. The notch is preferably placed in an essentially vertical position.

The thermal reflow is performed at a temperature that is greater than the softening point of the glass. For fused silica glass whose softening temperature is about 1650° C., thermal reflow is usually carried out at temperatures ranging from about 1700° C. up to about 2000° C. and, preferably, below about 1900° C.

If high purity and low levels of metal contamination are desired for the glass, thermal reflow is performed in a purifying atmosphere comprising a cleansing gas. The cleansing gas may be, for example, a halogen, a halogen-containing compound, or compatible mixtures thereof. Such halogen-containing compounds include HX, CₐS_{b}X_{c}, and compatible mixtures thereof, where X is at least one of F, Cl and Br, and a, b and c are non-negative integers that meet the valence requirements of the individual elements.

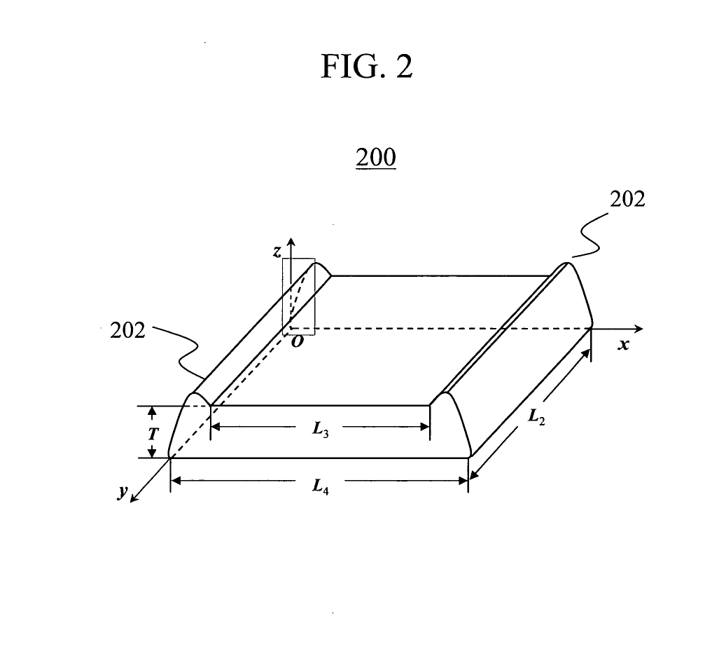

The results of thermal reflow are schematically shown in FIGS. 1 and 2. In FIG. 1, the ready-to-flow notched glass tube 100 is shown. Ready-to-flow notched glass 100 is reflowed and extended sideways to form a glass plate 200 (FIG. 2). Plate 200 is placed in a three-dimensional orthogonal coordinate system xOyz. The resultant glass plate 200 has two essentially flat major surfaces: a smaller upper surface with a width L₃ (shown above plane xOy); and a larger lower surface with a width L₄ (shown in plane xOy). Both surfaces have a length of L₂. The axis z is the optical axis of the glass plate. The larger surface having an area L₂·L₄ essentially corresponds to the outer cylindrical surface of the ready-to-flow notched glass tube B, and the smaller surface having an area L₂·L₃ essentially corresponds to the inner cylindrical surface 102 of ready-to-flow notched glass tube 100. The thickness T of the resultant glass plate 200 corresponds to the wall thickness 0.5·(OD₁−ID₁) of ready-to-flow notched glass tube 100. The plate having dimension of L₂·L₃·T represents the useable plate that can be extracted from the reflowed glass body. Typically, T<0.5·(OD₁−ID₁). Typically, L₃>π·ID₁, which means that the inner cylindrical cavity surface 102 is stretched during the reflow process. FIG. 2 shows an upwardly protruding part of the edge portion 202 of the reflowed glass plate 200. In practice, the edge portions 202 may have a different configuration, depending on the shape and dimension of the ready-to-flow notched glass tube 100, the notch 104, the reflow temperature, and time.

In another embodiment, described in U.S. Patent Application Publication No. US 2006/0137398 A1, by Daniel Joseph Bleaking et al., entitled “High Refractive Index Homogeneity Fused Silica Glass and Making Same,” filed on Jun. 9, 2005, the contents of which are incorporated by reference herein in their entirety, fused silica is provided by a soot-to-glass method in which soot particles are typically provided by flame hydrolysis of a silicon-containing precursor compound. In this embodiment, silicon-containing precursors such as, but are not limited to, silicon tetrachloride (SiCl₄), organosilicon compounds, such as, for example, OMCTS (octamethylcyclotetrasiloxane) and the like, are introduced into a flame of hydrogen, methane (CH₄), and the like, and are burned with O₂ to form silica soot. The flame hydrolysis may be plasma assisted. The silica soot may be deposited to form a porous body onto a supporting core cane or a mandrel, such as those in a typical outside vapor deposition (OVD) and vapor axial deposition (VAD) processes. If a mandrel is used to deposit the porous soot, it is usually removed after deposition to result in a hollow cylindrical shaped porous soot body before consolidation.

The porous soot body or preform may optionally be purified using methods known in the art, such as chlorine treatment and the like. If the silica soot preform is formed by using a chlorine-containing silicon precursor compound, such as SiCl₄, or chlorine, it may be desirable to strip chlorine from the preform before consolidation. Chlorine stripping can be done using various types of gases, including, but not limited to, O₂, H₂O (including D₂O and HDO), fluorine-containing compounds, Br-containing compounds, and the like, as well as compatible mixtures and combinations thereof.

Consolidation (also referred to herein as sintering) of the soot preform is usually carried out in the presence of an inert gas, such as helium, argon, and the like, as well as combinations or mixtures thereof. To obtain silica glass having a relatively high hydroxyl (OH) concentration—for example, at least 50 ppm—it is desirable to consolidate the soot preform in the presence of H₂O. The final OH concentration in the silica glass is partly determined by the partial pressure of H₂O in the consolidation atmosphere. Alternatively, consolidation of the soot perform may be carried out in the presence of other gases, such as H₂, D₂, O₂, fluorine-containing compounds, combinations and mixtures thereof, or the like.

After consolidation of the porous glass preform, the condensed glass may be further subjected to treatment in the presence of hydrogen, where H₂ molecules are loaded into the glass body to a desired level.

Regardless of the deposition method used, the local soot density of the preform should be sufficiently homogeneous. Initial local soot density in the preform prior to consolidation is one of the key factors that determine the final compositional homogeneity, especially homogeneity of OH concentration, in the consolidated glass. Therefore, the local soot density variation in a distance over 0.2 mm in the preform should be less than 20% of the overall bulk density of the whole soot preform, or less than 0.2 g/cm³, whichever is greater. In one embodiment, the local soot density variation in a distance over 0.2 mm in the preform is less than 10% of the overall bulk density of the whole soot preform, or less than 0.1 g/cm³, whichever is greater. The oscillation of burners during flame hydrolysis may be randomized or semi-randomized to obtain a high initial local soot density uniformity.

In another embodiment, a fused silica preform is provided by a planar deposition method described in U.S. Pat. No. 6,606,883 B2, by Kenneth E. Hrdina et al., entitled “Method for Producing Fused Silica and Doped Fused Silica Glass,” filed on Apr. 27, 2001 and issued on Aug. 19, 2003, the contents of which are incorporated by reference herein in their entirety. Silicon-containing precursors in either vapor or liquid form, such those described herein, are injected into one or more burners. The precursors exit the burners where they react to form soot, which collects on a planar surface to form a flat porous preform. The fused silica perform formed by planar soot deposition may then be subsequently dried by such methods as chlorine calcining, fluorine calcining, or combinations thereof. Calcining involves heating the soot preform and introducing a mixture comprising an inert gas and at least one of chlorine, fluorine and bromine into a chamber containing the soot preform. In one embodiment, calcining is carried out in an atmosphere consisting only of chlorine. The treatment by at least one of chlorine, fluorine, and bromine at high temperatures allows metal impurities to react, forming volatile metal chlorides fluoride, and/or bromides that are then removed from the preform. Chlorine also removes OH from the glass structure. Open pores are necessary for the gases to penetrate into the interior of the part. The preform may also be doped by other gases during calcining. For example, the preform may be doped with fluorine or D₂O, which may be beneficial for infrared transmission and deep-UV applications at 157 nm. Fluorine gas could be used either in combination with or instead of chlorine gas. After the drying process, the preform is fully consolidated into a clear, flat glass plate having a low concentration of OH moieties.

In one embodiment, the step of thermally reflowing the precursor glass cylinder is carried out in an atmosphere comprising a cleansing gas, as described in U.S. Patent Application Publication No. US 2007/0056662 A1, by James Gerard Fagan et al., entitled “Method for Suppressing Metal Contamination in High Temperature Treatment of Materials,” filed on Feb. 27, 2006, the contents of which are incorporated by reference herein in their entirety. By including a cleansing gas in the atmosphere during thermal reflow, contamination of the fused silica glass by metals such sodium, other alkali metals, and the like may be reduced to less than the part per million (ppm) level, and even down to the part per billion (ppb level) is feasible.

Cleansing glasses that may be used include, but are not limited to: F₂; Cl₂; Br₂; halogen-containing compounds such as HF, HCl, HBr, CF_{c}Cl_{d}Brₑ and SFₓCl_{y}Br_{z}, where c, d, e, x, y and z are non-negative integers, c+d+e=4 and x+y+z=6; and combinations or mixtures thereof. In one particular embodiment, chlorine (Cl₂) is used to treat fused silica.

The concentration of the cleansing gas—or gases—may range from 0.1% to 100% by volume. The actual concentration of cleansing gas in the atmosphere during reflow depends upon a variety of factors that include, but is not limited to, treatment time and temperature, the particular cleansing gas that is to be used, and the like. In one embodiment, the atmosphere under which thermal reflow is carried out consists only of the cleansing gases. In another embodiment, however, thermal reflow is carried out in an atmosphere that comprises an inert gas such N₂, He, Ne, Ar, Kr, and mixtures thereof in addition to the cleansing gas.

The pressure of the cleansing gas may be maintained at a constant value, varied periodically, or pulsed. Similarly, the choice of cleansing gas and other components of the atmosphere are determined by various factors, such as cleansing effectiveness, level of metal ions in the treatment environment, safety concerns, reactivity with furnace material, environmental concerns, controllability and cost, and the like. These gases should have a sufficiently high level of purity such that the gases themselves do not act as significant sources of impurities. Moreover, the cleansing gas should not react with fused silica in a manner that degrades the desired physical properties of the fused silica. The cleansing gas should instead have either a neutral or positive effect on the desired physical properties of the fused silica. For example, a fluorine-containing cleansing gas may be advantageously used, as fluorine does not detrimentally affect the optical properties of high purity fused silica for use in laser systems or lithographic devices. In addition, the use of fluorine-containing cleansing gas may improve the optical performance of the glass, as fluorine may displace chlorine in the glass because fluorine bonding with the glass backbone is more thermodynamically favored at high temperatures.

Table 1 lists OH concentrations and infrared transmission characteristics determined for fused silica glass samples formed in accordance with the present invention. The absorbance at 1.315 μm may be calculated from the fundamental absorption of OH at 2.72 μm. The high absorbance listed for fused silica glasses formed using the sol/gel process reflect the effect of overall impurity levels on the absorbance and the need to control levels of contaminants.

TABLE 1

| Glass Sample | | Absorbance (ppm/cm) |
|---|---|---|
| Forming Method | OH level (ppm) | at 1.315 μm |
| Preform consolidation | <0.009 | 26.4 |
| | <0.009 | 25.9 |
| Preform consolidation with | <0.03 | 19.6 |
| fluorine | | |
| Sol/gel | <0.01 | 99.4 |
| Sol/gel | <3 | 67 |
| | <3 | 31 |

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. A fused silica glass, the fused silica glass having an OH concentration of less than about 5 ppm of OH and having an absorbance of less than about 50 ppm/cm at a wavelength of about 1.3 μm.

2. The fused silica glass according to claim 1, wherein the glass forms an article having an optical aperture of at least about 75 cm².

3. The fused silica glass according to claim 2, wherein the article is an optical member.

4. The fused silica glass according to claim 1, wherein the OH concentration is less than about 0.1 ppm OH by weight.

5. The fused silica glass according to claim 1, wherein the fused silica glass has an index homogeneity measured at 632 nm of less than about 5 ppm over an aperture size of at least 75 cm².

6. The fused silica glass according to claim 5, wherein the index homogeneity is less than about 1 ppm.

7. The fused silica glass according to claim 5, wherein the OH concentration varies by less than about 2 ppm over an aperture size of at least 75 cm².

8. The fused silica glass according to claim 5, wherein the glass has a concentration of at least one of chlorine, fluorine, and bromine that varies by less than about 20 ppm by weight over an aperture size of at least 75 cm².

9. The fused silica glass according to claim 1, the fused silica glass has a chlorine concentration in a range from about 1 ppm up to about 1500 ppm by weight.

10. The fused silica glass according to claim 1, wherein the fused silica glass has a seed defect concentration of less than one seed per cm³.

11. The fused silica glass according to claim 10, wherein the fused silica glass has a concentration of seed and inclusion defects of less than one seed per 100 cm³.

12. The fused silica glass according to claim 1, wherein each seed or inclusion defect within the fused silica glass has a diameter of less than about 200 μm.

13. The fused silica glass according to claim 12, wherein each seed or inclusion defect within the fused silica glass has a diameter of less than about 50 μm.

14. The fused silica glass according to claim 1, wherein iron, nickel, titanium, germanium, lead, potassium, sodium, and lithium are each present in a concentration of less than about 4 ppb by weight, and wherein a total concentration of metals is less than about 10 ppb.

15. A fused silica glass, the fused silica glass having an absorbance of less than about 50 ppm/cm at a wavelength of about 1.315 μm, wherein the fused silica glass has an index homogeneity measured at 632 nm of less than about 5 ppm over an aperture size of at least 75 cm².

16. A method of making a fused silica glass, the method comprising the steps of:
a. forming a porous preform of silica soot, the preform having a predetermined density distribution; and
b. consolidating the preform at a predetermined temperature and under a controlled atmosphere to produce the fused silica glass, wherein the fused silica glass has an OH concentration of less than about 5 ppm and an absorbance of less than about 50 ppm/cm at a wavelength of about 1.3 μm.

17. The method according to claim 16, wherein the step of forming a porous preform of silica soot comprises depositing silica soot on a substrate by one of inside vapor deposition, outside vapor deposition, planar vapor deposition, a sol/gel process, vapor axial deposition, and combinations thereof.

18. The method according to claim 16, further comprising the step of thermally reflowing the fused silica glass.

19. The method according to claim 18, wherein the step of thermally reflowing the glass comprises thermally reflowing the fused silica glass in an atmosphere comprising at least one cleansing gas.

20. The method according to claim 19, wherein the at least one cleansing gas comprises at least one of F₂, Cl₂, Br₂, as HF, HCl, HBr, CF_{c}Cl_{d}Brₑ, and SFₓCl_{y}Br_{z}, wherein c, d, e, x, y, and z are non-negative integers, c+d+e=4, and x+y+z=6.

21. The method according to claim 16, wherein the controlled atmosphere comprises helium.

22. The method according to claim 16, wherein the OH concentration within the fused silica glass varies by less than about 2 ppm by weight over an aperture size of at least 75 cm².

23. The method according to claim 16, wherein the fused silica glass has a halogen concentration that varies by less than about 50 ppm by weight over an aperture size of at least 75 cm².
